(19) United States
(12) Patent Application Publication
(10) Pub. No.: US 2005/0032543 A1
(43) Pub. Date: Feb. 10, 2005

(54) Internet, cellular broadcast phone set and software

(76) Inventor: Jennipher Y. Adkins, Oakland, CA (US)

Correspondence Address: Jennipher Adkins, PO BOX 32121, Oakland, CA, 94604, US

(21) Appl. No.: 10/403,901

(22) Filed: Apr. 1, 2003

Related U.S. Application Data
(63) Continuation-in-part of application No. 09/733,830, filed on Dec. 11, 2000, now abandoned.

(51) Int. Cl. H04M 11/04

(52) U.S. Cl. 455/550.1; 379/37; 455/422.1

(57) ABSTRACT

An Internet, Broadcast, cellular telephone base device and mobile device that functions in tandem with Broadcast Software that provides a means to access the Internet and make telephone calls via and always connected ISP and/or via Cellular service. Base and mobile units can receive, store and process content submitted by broadcast software. The base and mobile units comprise of wireless technologies (i.e. Blue Tooth, satellite, cellular) that provide a means to switch telecommunication functions of mobile unit to the technological and economical advantage of enduser. Thus allowing land-based and cellular phone to function from same mobile device.

### FIELD OF THE INVENTION

The invention relates in general to a base and mobile device for receiving and transmitting audio signals via Plain Old Telephone System (POTS), wireless, and land-based technologies that maintain a constant Internet connection for same. Wireless technologies therein maintain a constant connection for base and mobile devices, and wireless and land-based technologies that maintain a constant, direct Internet and telephony connection for mobile handset. User can also utilize land based technologies when mobile device is within proximity to base device. Mobile unit has wireless technologies that receives and transmits video signals via integrated camera in same to remote devices including base device. Broadcast outlet in base and mobile devices operate in tandem with broadcast software.

### BACKGROUND OF INVENTION

The current invention has various objectives with regard to Internet usage, the Plan-Old-Telephone System (POTS), cellular phone service, wireless technology and visual communication using a telecommunication device.

### DESCRIPTION OF RELATED ART

Currently, the primary way to utilize phone services offered via the Internet, one must purchase a computer, separate headset, logon to the Internet then go to the telephone website.

The user must close or minimize other applications and/or otherwise alter their computer screen in order to make a call using a Internet based telephone service.

Another way to complete a telephone call using the Internet are plain old telephones that require user to initiate dial-up Internet access by pushing a button.

In order to provide back ground information so that the invention may be completely understood and appreciated in proper context, research was conducted for prior art.

U.S. Pat. No. 6,169,734 B1, issued Jan. 2, 2001, Wilson, offers Internet access using the Plain Old Telephone System platform. This invention's Internet access is via a dial-up connection and is not always on, nor does it offer the ability for back-end and front-end users to create, view, respond and archive broadcasted media, camera usage or wireless communication. Nor does said invention provide a UPS as a form of backup power. Nor does this invention offer the ability to create maintain or access, via an external menu (DAM Menu), user settings, functions and features as present invention does. Nor does this invention maintain a constant Internet connection, provide a mobile device that functions both as a cell phone and a regular hand set.

### OBJECTS AND ADVANTAGES

The present invention comprises: a base and mobile telephony device having a display that allows constant access to the Internet, (i.e. via DSL, satellite micro wave, and/or other methods) of access to web pages, provides Broadcast Software to create and view customized broadcasted announcements/advertisements (announcement/ad), email and Internet access via integrated Internet Service Provider (ISP) software, web hosting of announcement/ads, a web browser and wireless communication technologies.

This is partially achieved by proprietary Broadcast Software (“BS”), a web browser, an Internet Service Provider (“ISP”), and hosting services.

Broadcast Software will allow business entities (businesses, government and others) Broadcast Announcement/ad Capabilities (“BAC”) twenty four hours a day. Broadcast Software will have pre-designed templates that will allow for the production of custom announcement/ads that will broadcast primarily on display to each Internet Protocol (IP) address, and telephone number of present invention. Web portals will also be recipients of Broadcast Software productions also accessible from a personal computer when URL (Universal Resource Locator) is searched on WWW (World Wide Web).

Broadcast software will have, but not be limited to the ability for the back-end user (business entity) to create an announcement/ad to be broadcasted by selecting front-end page set-up template, demographics (who will see the announcement/ad), “run” time schedule and, broadcast allocation areas (i.e. back-end user/business entity will have options as to where part or all of their announcement/ad information will appear when front-end user selects various functions from base and/or mobile device).

Broadcast software will also allow business entity to send individual updates to their recipients or customers, track performance and usage of current and past announcement/ads, make payments and complete other electronic business functions currently in use in today's market. Broadcast Advertising Interaction (“BAI”) allows the front-end user to interact with content shown on display by responding to viewed media, such as making a purchase, requesting information, saving announcement/ads or becoming a customer.

Above functions are combined with telephone components, where phone calls can be made and received via constant Internet access or the Public Switched Telephone Network (“PSTN”) or land based method or wireless service.

A Direct Access Menu (“DAM”, i.e. which provides users external push button access to functions and features from base and mobile units such as Call Logs, Personal, Yellow Pages and Announcement/ad Directories, Security Settings, Purchases/Billing/Payment Index).

Mobile unit is an Internet ready, mobile device that provides wireless or cellular telecommunication but within proximity to base unit Same device is communicably connected with base unit via a wireless connection (i.e. technology like “Blue Tooth” or similar). Whereby, incoming and outgoing calls no longer access wireless telecommunication (cellular) network to be completed, by utilizing telephony connection of base unit, thereby conserving minutes by minimizing cellular use.

Mobile device also provides access to camera component, announcement/ads, email and other telephone functions.

Base and mobile devices also provide but are not limited to: internal high speed modem, microprocessor, RAM memory, wireless communication receiver and transmitter, Universal Power Supply (“UPS”). Base unit provides ac/dc cord, telecommunications cord, peripheral ports (i.e. for external key board, monitor, cell phone charger, palm charger) combined with other standard components necessary to achieve this invention.

When utilizing current invention's dual telecommunication ability, users can now use their home phone as their cell phone and vice versa. The base and mobile unit communicates via wireless technologies telecommunication median to be used for incoming and outgoing calls is based on the proximity of the devices. Users can also have additional, uniquely identifiable mobile units (different telephone numbers and IP addressee) for family members or matching units (telephone numbers and IP addressee same as master)to use for dedicated purposes (i.e. one can be a home based “handset” and second could be cellular “mobile unit”).

When utilizing the current invention's camera component, users can surveille an area with ease. The user only has to position mobile device consisting of camera component in the area to be watched. Images will appear on display of base unit or a receiving unit.

In emergency situations, this device can serve as an emergency information center by utilizing its UPS system in the event of a power outage. Users will still have access to important instructions and updates offered via ISP and Broadcast Software (Internet or intranet) for as long as the backup power lasts.

As a communication median, the Internet has the potential to be the most efficient and cost effective in mass reachability. The current invention provides an optimal means to disseminate information and advertise products and services.

By using this invention, shopping could be encouraged by offering a revolving line of credit with standard telephone service. Users could apply purchases to their telephone bill, in addition to other methods of completing a purchase.

Not only can the majority of home in the United States not receive the multitude of benefits the Internet provides, this technology void also indicates a tremendous forfeiture of revenue from nonexistent sales. This technology void has been termed the “Digital Divide” (“DD”)

The present invention addresses the Digital Divide (“DD”) by combining Internet access and the ability to view and purchase from always on streaming advertisements and broadcasted media via a common household device, the telephone.

Some users may also opt to customize what appears on their display by selecting desired content to be streamed (i.e. important email alerts, date/event alerts combined with photos, breaking news and stock prices, or even which business entity is advertising, the lowest cost of milk).

Whichever manner is selected to access announcement/ads, this device gives users the ability to search Broadcast Software database for goods and services(locally or nationally), complete a purchase, and maintain a purchase history record.

By broadcasting content on the current invention, companies, government entities and others can now target the most unique and exact target market for their message. For example, when a front-end user (also referred to end user) attempts to make a long distance telephone call, using the easily accessible (“DAM”) menus, they would now be able to compare broadcasted or advertised long distance rates by multiple carriers and complete the call using the best selection.

Having a UPS, would especially be important during emergencies, or power outages because it would provide full power to the base device for a period of time, whereby business entities can send urgent messages, information and instructions.

The Direct Access Menu (“DAM”) of this device also combines functions such as easy access to call history, personal and national directories and features such as the ability for the end user to program user settings, save favorite or regularly needed announcements (or company access),pay bills, view past purchases, receive and pay bills, and view a customer service area.

The present invention will acclimate low to middle income households to the efficiencies of using the Internet at home. Primarily because they will not be required install programs, decide which hardware or software to purchase or learn how to operate a an unfamiliar device.

This is also needed preparation for federal legislation that has already been mandated that requires homes built after 2010 be wired with multimedia, fiber optic cabling as a standard.

There are other objects and advantages remaining in specification and drawings. There is nothing on the market that offers the same benefits as present invention does.

### SUMMARY OF INVENTION

It has been found that prior telecommunication systems using the Internet have limited functions and do not provide broadcasted announcements specifically targeted for individuals or offer dual landbased, cellular functionality.

As such, it is a primary objective of the present invention is to provide a device that integrates hardware components of a standard telephone device and Broadcast software that has constant access to the Internet, that disseminates targeted broadcasted media and provides easily accessible telephone functions and features.

In this regard, a device which supports Internet audio protocol standards G.723, G.725 and G.729 and standard analog audio protocol G.711 for all phones provided.

In one embodiment, the present invention defines an Internet telephone with an internal modem that remains connected to the Internet. Present invention has an integrated display screen with integrated display electronics that renders visual call progress information to the user as well as other communications indicators and other relative information on same.

Another object of the present invention is to provide a device which is similar to the Plain Old Telephone System (“POTS”). Including a phone keypad for Dual Tone Multifrequency (“DTMF”) dialing. Device can be used to make voice connections via the PSTN and digitally compressed audio using the Internet protocol. Device will have touch screen keyboard and navigational access of the visual interface to content as it appears on display.

Internet access is constant on present invention. User may program device to utilize certain Internet telephone service providers by accessing(“CALLS”) button in base unit to access the-most current rates broadcasted into network by business entities using Broadcast Software. Otherwise the device will arbitrarily select any available Internetbased call provider to complete call when user attempts to make a non-local call.

Another object of the present invention is to offer front-end users the ability via Broadcast Software to receive, view and save real time broadcasted messages on a telephony device. Also with the ability to respond, purchase and research incoming activities (content, announcement/ads that solely appear in non-streamed or dormant locations from the DAM.

Another object of the present invention is to offer back-end users (business entities) the ability to produce and disseminate content, announcement/ads to a super targeted audience using Broadcast Software that appears on displays of base and mobile units of current invention.

Another object of the present invention is to provide business entities (i.e.. companies, government entities and others) the ability to access web based Broadcast Software at anytime, to create content, announcement/ads to be disseminated to the public via present invention using the Internet.

Another objective of current invention provides for a national, household emergency communication device comprising of Internet access, a display and UPS backup in the event main power is lost, and/or the there is an urgent message to be broadcasted from the National Emergency Broadcast System and where telephone service or wireless telephone communication is still intact.

There are various ways users may utilize present invention to contact others when main power is lost which consists of land line telecommunication, Internet based telecommunication, wireless telecommunication(i.e. when Internet and/or telecommunication signal is via satellite) and via sending and receiving email messages.

Yet another object of current invention is to offer back-end users/business entities the ability to create a default announcement/ad in the event telephone service interruption. This service mode will allow pre-paid calls to be made until normal service is restored. Interrupted service mode will also allow for emergency communication.

Another object of the present invention is to provide users the ability to control access and maintain security by adding “User Settings” to the POTS using internal memory area. This will enable users to select from a menu on how to customize their base and mobile unit displays, create their individual profile, unidentified by their Internet protocol (“IP”) address and their telephone number.

Yet another object of the present invention is to provide a mobile unit that is similar to POTS functionality that also has a wireless communication means with a base unit in which both share and provide the same information on respective displays. Mobile unit will also feature push button access that allows user to switch functions of the device. Mobile unit will also provide a camera to capture and transmit images to base unit or a remote receiver.

Yet another object of the present invention is to provide a base unit that allows multiple mobile units to be charged from central docking area to re-establish security protocols for security measures, access limitations, and information updates.

Yet another object of the present invention is to offer a mobile unit that will provide both wireless/cellular Telecommunication and a home hand-set. When mobile unit enters a receiving range to base unit it will switch from cellular based telecommunication to non-cellular based telecommunication to complete calls. Alternatively, when it exits same range, mobile unit will seek telecommunication from another means (i.e. cellular, satellite, etc..). Base and mobile unit can maintain relationship based on dedicated access numbers stored in base unit. There by allowing base unit to be moved within certain locations while still providing full telecommunication services to end-user.

For a more complete understanding of the present invention, including features and advantages, reference is now made to the following detailed description, taken in conjunction with the accompanying drawings and diagrams.

### BRIEF DESCRIPTION OF DRAWINGS

FIG. 1 illustrates a prior art Internet Phone;

FIG. 2 is a top.side view of the Internet, Cellular Broadcast Phone Set according to the present invention; and

FIG. 3 is a detailed circuit diagram for the Internet, Broadcast Phone according to the invention; and

FIG. 4 is a detailed flow chart for Broadcast Software for back-end users.

FIG. 5 is a detailed flow chart for Message Button, announcement/ad access for front-end users.

FIG. 6 is a detailed flow chart for Directories Button, announcement/ad access for front-end users.

FIG. 7 is a detailed flow chart for Display access to announcement/ad for front end users.

FIG. 8 is a detailed flow chart for Purchase/Billing Button,:announcement/ad access for front-end users.

Corresponding numerals refer to corresponding parts in the figures unless otherwise indicated.

### DETAILED DESCRIPTION

The present invention FIG. 1, a prior art Internet phone is shown and denoted generally as 8.

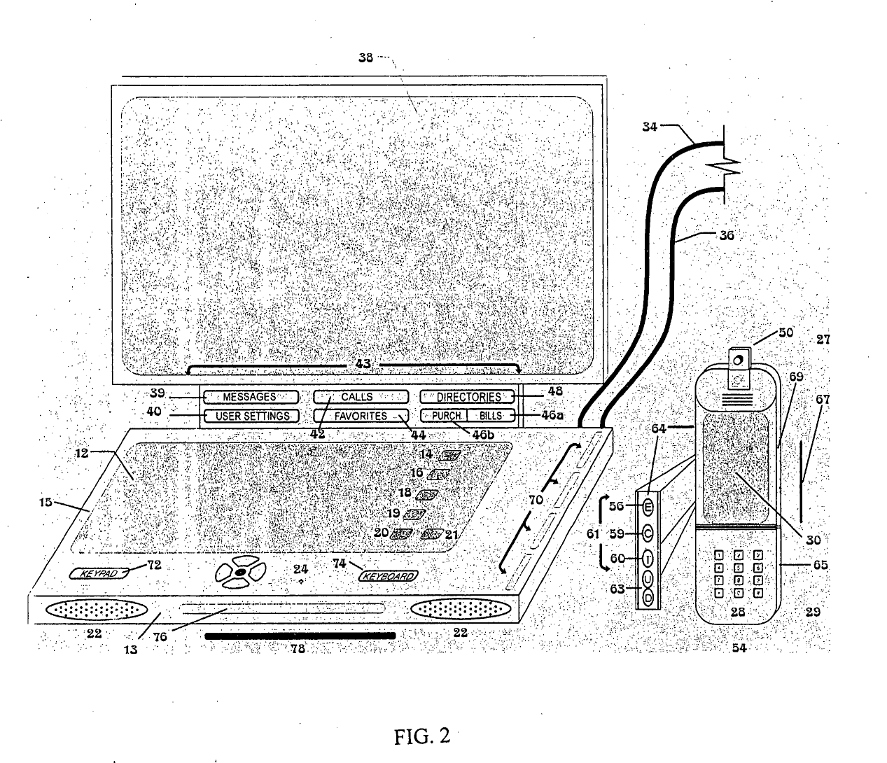

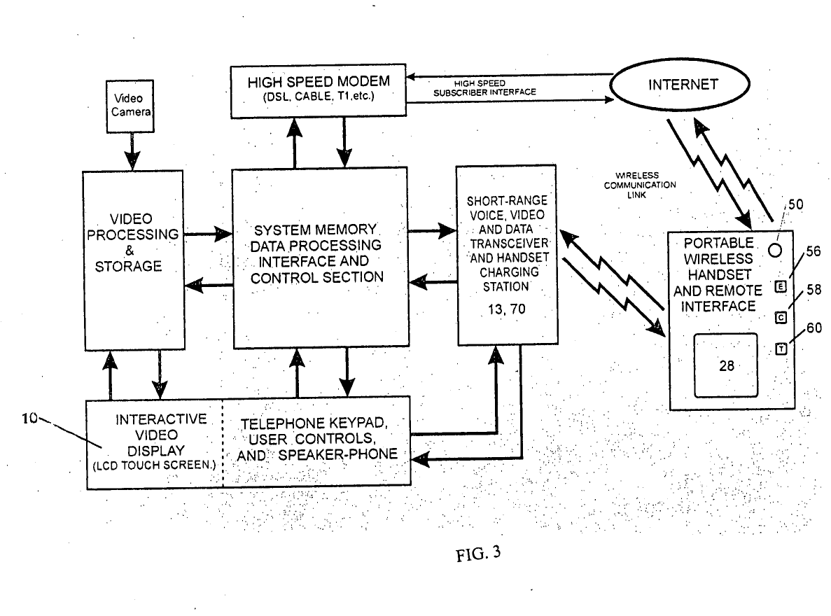

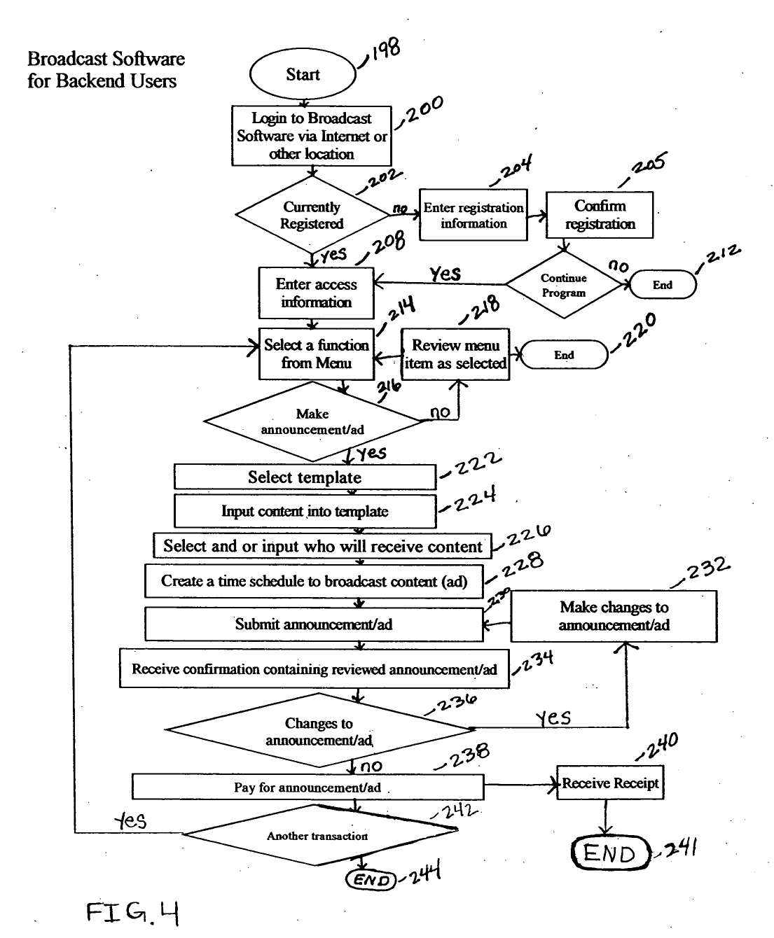

Turning now to FIG. 2, the Internet, Cellular Broadcast phone 10 of the present invention is shown. Overall unit 10 has many features of a standard Plain Old Telephone System (“POTS”) including a base unit 13 and a mobile hand set 28 for hearing and speaking.

The method of current invention comprises of software programs (i.e. ISP software, hosting software, telecommunication software and broadcast software) and technologies(PSTN, Cellular, wireless communication).

The physical base unit 13 and mobile unit 28 houses various telecommunications devices as herein described and as can be appreciated by those skilled in the art.

Accessible from the top 15 of the physical base 13 are various buttons and input devices which control the operation and functionality of the Internet, Cellular, Broadcast phone base unit 11.

A numeric key pad button 72, toggles with alphanumeric keyboard button 74 to provide touch screen devices using same area 12A,12B on top 15 of physical base 13. Virtual numeric keypad 12A device provides identical Dual Tone Multifrequency (“DTMF”) push button operation similar to a POTS. Virtual alphanumeric keyboard 12B provides QWERTY type interface which the user can enter alphabetic and numeric entries and messages to be included in the Internet message stream. The Alphanumeric keyboard 12B device functions as an input device of a typical desktop computer.

A stylus attached by a retractable cord 78,67 onto physical base 13 and onto one side of mobile handset 65 facilitates the-operation of numeric keypads 12A,30A and alphanumeric keyboard 12B,30B by pressing one end of stylus on desired symbol located on the numeric keypad 12A,30A and alphanumeric keyboard 12B, 30B, corresponding information appears on display 30,38. User can also accomplish exact result by the use of a finger or other object by applying pressure. When stylus is not in use, it may be stored in receptacle 76,69.

Navigation Control Center 80 allows user to navigate corresponding information as it appears on Display 30

As shown, the mobile unit 28 receives communication capabilities via being communicably integrated to physical base 13 by wireless communication.(i.e. Blue Tooth, microwave, DSL, direct satellite connection)and telecommunication devices (cellular, satellite)and/or other external wireless communication connections as herein described and as can be appreciated by those skilled in the art.

Handset 28 has an earpiece 27 and a mouthpiece 29 that serve the same function of that of a POTS. Mobile unit 28 can be used to transmit and receive pure analog audio signals, which are digitized and processed for transmission on network.

The multi-dock charging cradle 70 provides power to mobile unit 28. Mobile unit 28 has internal software (not shown) to provide full operational, navigational and camera use.

Push buttons 56,58,60, 63 are shown on side of handset 64 that provides external switch control to operational modes and function of handset.

An “E” button 56 located on side of handset 64 is pressed for immediate access to email functions via virtual menu (not shown) appearing on handset display 30.

A “C” button 58 located on side of handset 64 is selected for immediate access to camera functions via virtual menu (not shown) appearing on handset display 30. User may also access camera functions 59 and camera lens 50 by flipping up lowered lens 50 to the “on” position.

A “T” button 60 allows immediate access to telephony functions via virtual menu (not shown) appearing on handset display 30.

Volume control while handset is in use can be controlled by press “up” arrow or “down” arrow on external volume adjuster 63.

Multi-cradle charger 70 will provide a charging station for mobile unit 28. To do so, user may place mobile unit in charging prongs (not shown), with display facing up, onto cradle contact prongs (not shown)located inside cradle 71. Mobile unit may also be charged using a standard AC/DC adapter.

Mobile unit modes' 61 back-end functionality may overlap (i.e. to service incoming email when user is in telephone or camera mode). User may also customize display 30 of mobile unit to give comprehensive updates of features that can be shown on its display 30 when phone is idle (i.e. number of calls missed, new mail received or if sent mail has been opened, type of telecommunication in use).

A microphone 24 located on face 15 provides for the transmission of audible signals from user. Speaker 22 located on base 15 provides for the reception of audible signals to the user. Alternatively, audio signals can be received and transmitted via mobile unit 28.

Integrated display 30,38 is provided to give the user visual information about the current Internet connection and any other information.

Display 30,38 allows viewing access to virtual prompts including keypad 12A,30A for dialing numbers and alphanumeric keyboard 12B,30B for text input.

Prompts and indications for functions initiated from face 15 of base unit 11 will appear on Primary display 38. Prompts and indications for functions initiated from handset 28 will appear on handset display 30.

The display screen 38 can show visual response when a button is pushed on a Direct Access Menu (“DAM”)43. Direct Access Menu (“DAM”)43 buttons 39,40,42,44, 48,46A,46B will have various features accessible from the physical base unit 11. When a Direct Access Menu(“DAM”) 43 button 39,40,42,44, 48,46A,46B is pressed, the corresponding virtual menu appears (not Shown) on base unit display 38. Navigation Control Center 80 allows user to navigate corresponding information as it appears on base unit display 38.

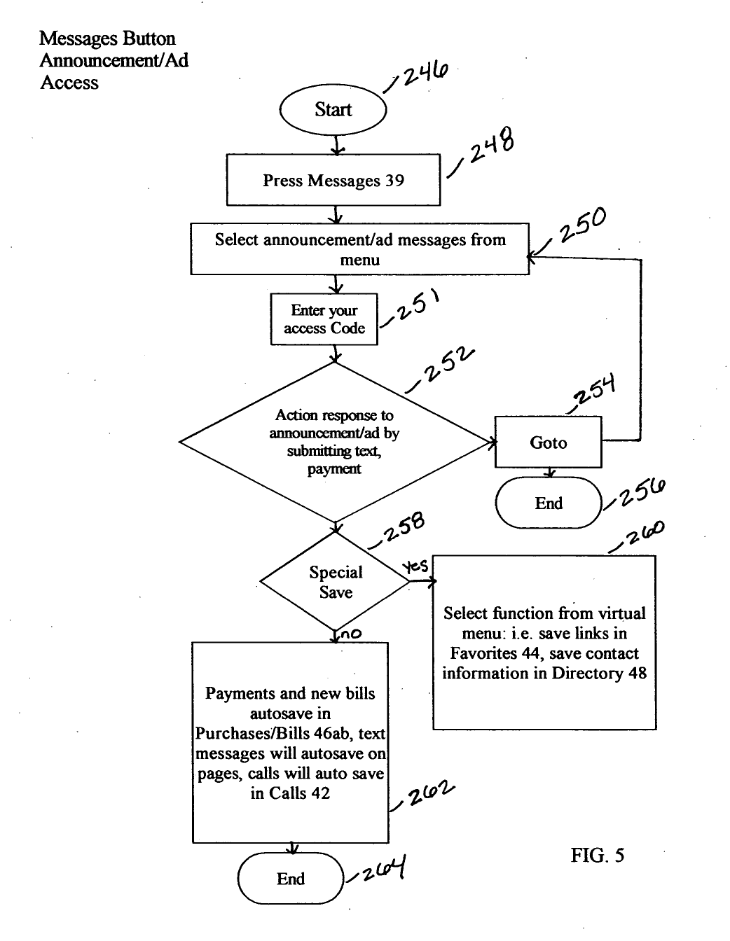

A “Message button” 39, may provide but not be limited to access to email messages received via Internet protocols and voicemail messages received on internal or external digital recorder (not shown) and the ability to manage these services (i.e. create outgoing message, set remote access code, save and erase messages). The “Message button” 39, also allows front end user to access individualized quick notes (i.e. for example the pharmacist would have the ability to send a notification that a prescription is ready using an identifier other than an email address, such as phone number, account number) created by back end user with Broadcast Software, (see FIG.5 for front-end usability, FIG. 4 for back-end usability).

A “User Settings” button 40 will provide but not be limited to security code management, ringer type selection, language setting, email set-up, trouble shooting instructions, calculator, calendar/planner, direct access to customer service and the ability to customize display 30,38.

A “Calls” button 42 may provide but not be limited to call logs (i.e. incoming, outgoing with date and time)and the ability to dial directly from log using the navigation and selection function of the navigation control center 80. The “Call” button 42 also allows user to forward incoming calls to a desired number after inputting security code

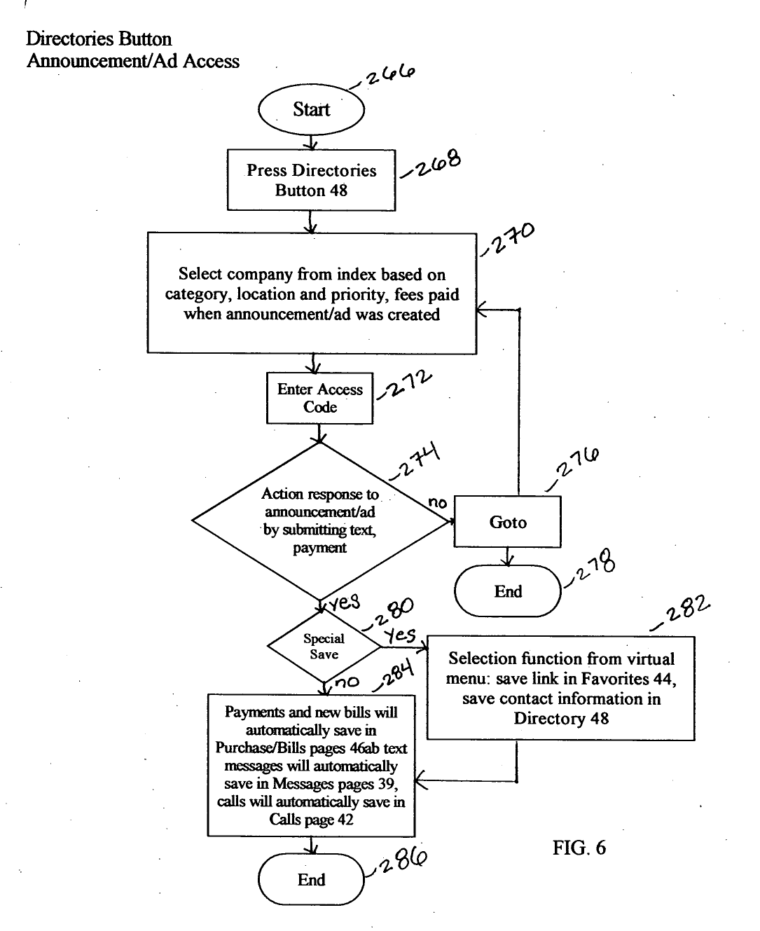

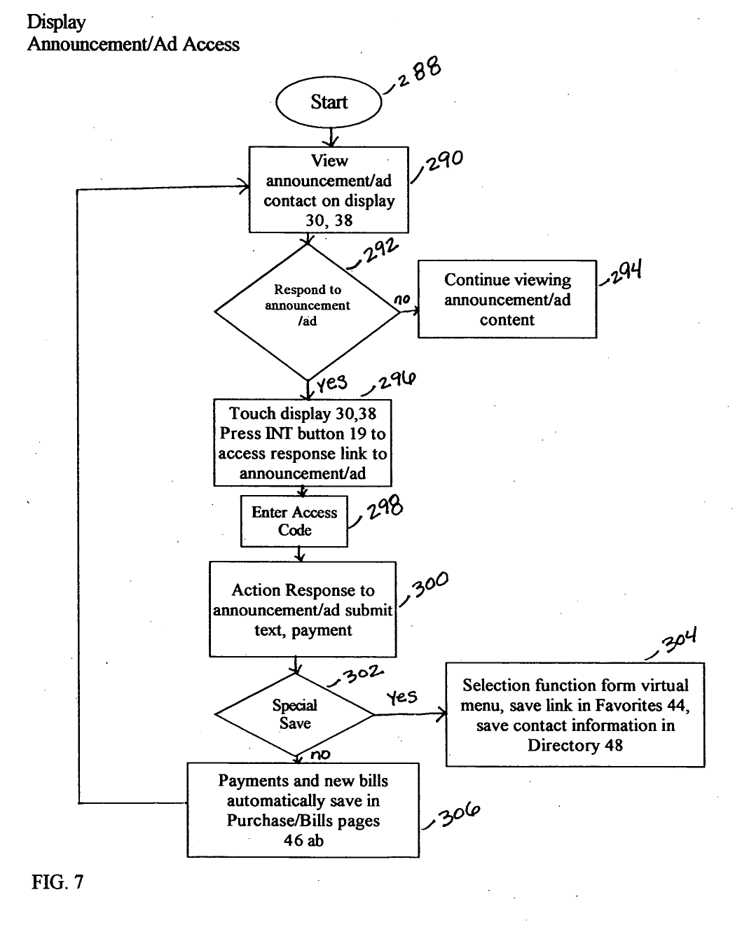

A “Directories” button 48 provides user the ability to input, save and view contact information as a personal directory. The telephone number and the email address fields in personal directory are accessible using navigation and selection operations 80. The “Directories” button 48 also provides access to the “Online Yellow Pages,” (not shown)web based directory. Directories button 48 also allows front end user to access indexed announcements created by back end user with Broadcast Software, organized by category, state, and priority base on announcement cost (see FIG.6 for front-end usability, FIG. 4 for back-end usability).

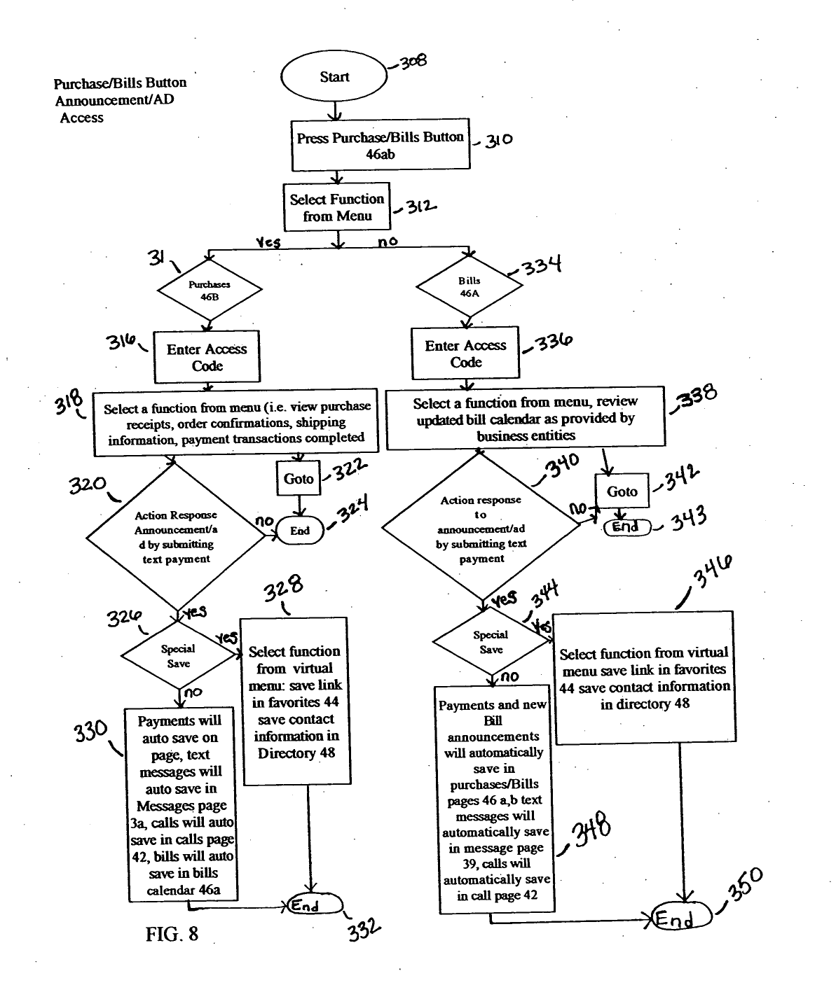

A “Purchase/Billing,” button 46A,46B allows user to maintain and view payment and billing logs. Purchase page 46A allows front end user to view payment transaction including receipts, order confirmations, shipping information, and overall historical payment record for all transactions. Billing page 46B allows-user to view bills from monthly Bills Calendar, pay bills and maintain a list of accounts that can also indicate balances, updated by back-end user of Broadcast Software by the respective business entities (see FIG.8 for front-end usability, FIG. 4 for back-end usability).

Payment for purchases can be debited to telephone bill or a prearranged monetary account or purchases can also be completed by other standard and acceptable methods.

Central data base (not shown) housed in memory of physical base of unit (not shown) and in memory of mobile unit(not shown), can mutually update when new information via wireless communication that has been entered (i.e. telephone book entry, call logs, email history) when both are in proximity and/or when mobile is re-docked in docking station 70. Present invention will also have means for remote telephonic access to central database for the retrieval of personal directory information and voice and email messages.

To complete land based calls, user may input phone number using dial pad 12A. User may also press “calls” button 42 on DAM 43, or “T” button 60 on mobile unit 28.

To complete Internet based calls user may also select an Internet call provider by pressing “Calls” button 40 on DAM or “T” button on hand set 60 or “INT” button 19 shown on face 15 of physical base 13.

User may then select from an internal list of broadcasted carriers (business entity) that have created a specialized announcement using Broadcast software (see FIG. 4) that broadcasts their most current prices on display 30,38. Broadcasted information can also include the ability for front-end user to establish a reoccurring account with business entity.

Commonly used telephone features such as flash button 14 for call waiting, redial button 16, mute button 18, INT button 19 (for Internet services), call forward button 20 and speaker button 21 is provided on face 15 of base unit.

Referring now to FIG. 4, the broadcast software flow chart is shown.

Broadcast software allows back-end user to create broadcast content, announcement/ad to be accepted by Internet, Cellular, Broadcast Phone Set and shown on display 30,38.

Business entity must register 204 to acquire access information (login name, password, email address) before accessing menu functions 214 of Broadcast Software.

Announcement/ad is created 216 using Broadcast Software by initially determining scope or what will be in the announcement/ad, (i.e. determine level of content—create broad based announcement/ad with pictures, streamed media or text only for a large targeted audience), the type or who will receive the announcement/ad (i.e. create discreet announcement for bills, confirmations, invitations for individual, specified customers or recipients) and “nesting” location or where will the content reside for front-end accessibility (i.e. nesting refers to where the announcement/ad will be directed to appear, primary displays 30,38,, “Directories” 48 page, “Message” 39 page and/or “Purchase/Bills” 46 page, and/or web portal.

Back-end user can also select other functions from menu 214 that comprise, but are not limited to, account management, customer data base management, competitive tracking reports, receipt confirmations, logistical tracking and payment section.

After back-end user has completed necessary steps to create the announcement/ad 222,224,226,228, an initial creation of announcement/ad is sent to a customer service support group 230 before it is disseminated to the public via base 11 and mobile unit 28. This function will serve as a “check,” for misspellings, vulgarities, obvious mistakes and to serve as a confirmation of the validity of the announcement/ad to ensure responsible business entity is aware of transaction and agrees to all terms, conditions, fees and what will be broadcasted/hosted.

If no changes are made to the first draft, the business entity accepts and confirms announcement/ad 234 and establishes payment for the broadcast and hosting service 238. Although the present invention has been described above with reference to preferred embodiments thereof, many variations, modifications and adaptations thereof, will become apparent to those skilled in the are which embody the concepts disclosed by the present invention. Accordingly, all such variations, adaptations, etc. are deemed to be part of the invention which is further defined by the claims recited below.

1. A Plain Old Phone with constant Internet access and hosting connectivity comprising:

2. A mobile unit in claim 1 wherein a means to provide cellular service and land based service in same.

3. A mobile unit in claim.2 wherein a circuit is provided to alternate multiple telecommunication services and communication statuses, whereby user may receive benefits of land based telephony technologies, not cellular or wireless telephony technologies whenever possible.

4. A mobile unit in claim 3 wherein an integrated camera transfers captured images to a remote device.

5. A software facility operated by claim 1 and claim 2 that provides a means to process electronic data, whereby same data can be created, viewed, responded to stored, updated comprising of the following steps:
(a) storing information for designated areas to be accessed using Internet, Broadcast, Cellular Set
(b) forming a time sensitive data base as instructed by back-end users of said information to be disseminated to predetermined locations
(c) providing a means for front-end user to interact with said information, wherein the response will be stored on said designated areas to be access by back-end user
(d) providing a means to host same.

6. A circuit in claim 1 wherein a housing structure provides power producing enclosure for multiple mobile units.

7. A circuit in claim 1 further comprising a data port jack supporting standard protocol communications with a personal computer.

8. A circuit in claim 1 wherein a modem is coupled to phone line.

9. A circuit in claim 8 wherein said modem is programmable.

10. A circuit in claim 8 wherein said modem includes signal processing support for multiple signal transmissions, compression and correction of protocols and constant Internet connectivity.

11. A circuit in claim 1 comprising: a display driver circuit
a display screen is connected to said display driver.

12. A circuit in claim 2 comprising:
a display driver circuit a display screen is connected to said display driver.

13. A circuit in claim 1 comprising: a permanent memory area storing multiple telecommunication and wireless communication program segments including Internet access and wireless protocols.

14. A circuit in claim 2 comprising: a permanent memory area storing multiple telecommunication and wireless communication program segments including Internet access and wireless protocols.

15. An erasable memory area in claim 1 wherein stores multiple Internet access parameters and data created by frontend user.
